(19) United States
(12) Patent Application Publication
(10) Pub. No.: US 2025/0348082 A1
(43) Pub. Date: Nov. 13, 2025

(54) METHOD AND APPARATUS FOR GENERATING MOVEMENT PATHS OF PLURALITY OF DRONES FOR INSPECTION OF INDUSTRIAL STRUCTURE

(71) Applicant: NEARTHLAB INC., Seoul (KR)

(72) Inventors: Jae Han IM, Seoul (KR); Byung Yoon LEE, Seoul (KR)

(73) Assignee: NEARTHLAB INC., Seoul (KR)

(21) Appl. No.: 18/868,109

(22) PCT Filed: Jun. 5, 2023
(86) PCT No.: PCT/KR2023/007669

§ 371 Date: Nov. 21, 2024

(30) Foreign Application Priority Data
Jun. 8, 2022 (KR) 10-2022-0069335

(51) Int. Cl. G05D 1/644; G05D 1/646; G05D 1/69; G05D 105/80; G05D 107/90; G05D 109/25; G05D 111/30

(52) U.S. Cl. CPC G05D 1/644; G05D 1/646; G05D 1/69; G05D 2105/89; G05D 2107/90; G05D 2109/254; G05D 2111/30

(57) ABSTRACT

According to some aspects of the disclosure, a path generation apparatus for generating a movement path of at least one drone for inspection of an object, the path generation apparatus comprises a problem solving unit configured to output a solution by solving a vehicle routing problem model by using a metaheuristic technique with respect to a graph in which a connection relationship among a plurality of checkpoints included in the object is defined as a target and a path generation unit configured to generate the movement path of the at least one drone based on the outputted solution.

### TECHNICAL FIELD

The disclosure relates to a method for generating movement paths of a plurality of drones for inspection of an industrial structure. Specifically, the disclosure relates to a method for generating movement paths of a plurality of drones for checking of an industrial structure, which sets optimal movement paths for movement of drones based on a plurality of checkpoints that are preset depending on the structure, exterior, and characteristics of the industrial structure.

### BACKGROUND

The contents described in this section are merely to provide background information about the present embodiment, but do not constitute the prior art.

Recently, with the 4th industrial revolution, an imaging technology using drones is being commercialized and incorporated into many technologies. In particular, attempts to apply a drone technology to industrial sites and the development of related technologies are under way.

In the related art, a method for checking the state of an industrial structure has been performed in a manner that images of main areas of an industrial structure are captured by using a telephoto camera, or a person approaches the corresponding areas directly and proceeds with the inspection. However, the method using the telephoto camera has the disadvantage in that it is difficult to check the accurate results, whereas the method in which a person conducts an inspection directly has the disadvantage in that a large number of people and various equipment are required with the risk of accidents, and thus a lot of time and money are required.

Accordingly, there have been needs for a technology to utilize drones for inspection of an industrial structure, and needs for a method and an apparatus for generating movement paths of a plurality of universal drones, which are applicable to industrial structures of various sizes and shapes, are being demanded.

Further, in case of inspecting an industrial structure by using drones, it may be preferable to conduct an inspection by using a plurality of drones in consideration of the size and the structure of the industrial structure. Accordingly, needs for a method and an apparatus for generating optimal movement paths of a plurality of drones, which can consider capacities and costs of batteries of the drones and can prevent drone collisions, are also being demanded.

### DETAILED DESCRIPTION

### Technical Objectives

It is an object of the present disclosure to provide a method and an apparatus for generating movement paths of a plurality of drones for inspection of an industrial structure, which identify paths on which the drones are movable and paths on which the drones are unmovable at a plurality of checkpoints based on industrial structure information, and derive optimal movement paths of the drones by optimizing a vehicle routing problem model so that the operation efficiency of the plurality of drones is maximized through a metaheuristic technique.

Further, it is another object of the present disclosure to provide a method and an apparatus for generating movement paths of a plurality of drones for inspection of an industrial structure, which can be configured to further solve a vehicle routing problem model through an exact solution, and determine a solving technique between the exact solution and the metaheuristic technique based on the number of the plurality of checkpoints. Accordingly, an accurate result that responds flexibly to on-site conditions is transferred.

The objects of the present disclosure are not limited to the objects mentioned above, and other objects and advantages of the present disclosure that have not been mentioned can be understood by the following description and will be more clearly understood by the embodiments of the present disclosure. Further, it will be readily appreciated that the objects and advantages of the present disclosure may be realized by the means set forth in the claims and combinations thereof.

According to some aspects of the disclosure, a path generation apparatus for generating movement paths of a plurality of drones for inspection of an industrial structure, the path generation apparatus comprises: a data transceiver unit configured to receive industrial structure information and a plurality of checkpoints of the industrial structure, a path identification unit configured to, identify a path on which the drone is movable and a path on which the drone is unmovable at the plurality of checkpoints in consideration of the industrial structure information, and define a connection relationship of the checkpoints corresponding to the path on which the drone is movable, a graph completion unit configured to complete a relationship of the plurality of checkpoints by defining a virtual path between the checkpoints where the connection relationship is not defined; a problem solving unit configured to output a solution by solving a vehicle routing problem model configured based on the plurality of checkpoints; and a path generation unit configured to generate the movement path of the plurality of drones based on the outputted solution, wherein the movement path of the plurality of drones includes sub-movement paths corresponding to the plurality of drones, respectively, wherein the problem solving unit is configured to, search for a solution based on a weight according to the connection relationship of the plurality of checkpoints, evaluate fitness by performing conformity evaluation for the searched solution based on operation efficiency for the plurality of drones, end problem solving in case that the evaluated fitness satisfies an algorithm end condition, and solve the vehicle routing problem model through a metaheuristic technique configured to repeat the problem solving by changing the weight in case that the evaluated fitness does not satisfy the algorithm end condition, and wherein the problem solving unit is configured to, end the problem solving, and output the searched solution in case that the problem solving is performed as many times as the preset number of repetitions of the problem solving.

According to some aspects, the metaheuristic technique is an ant colony system (ACS), and wherein the problem solving unit is configured to search for the solution by further utilizing pheromone information accumulated in an existing path as a positive feedback.

According to some aspects, the problem solving unit is further configured to solve the vehicle routing problem model by an exact solution, wherein the problem solving unit is configured to determine a solving technique of the vehicle routing problem model either the metaheuristic technique or the exact solution according to the number of the plurality of checkpoints of the industrial structure, and wherein the problem solving unit is configured to: solve the solving technique of the vehicle routing problem model through the metaheuristic technique in case that the number of the plurality of checkpoints of the industrial structure exceeds a preset reference checkpoint threshold value, and solve the solving technique of the vehicle routing problem model through the exact solution in case that the number of the plurality of checkpoints of the industrial structure is equal to or smaller than the preset reference checkpoint threshold value.

According to some aspects, the vehicle routing problem model is configured so that the overlapping checkpoint between the sub-movement paths corresponds to only a starting point (depot) in consideration of battery capacities of the plurality of drones.

According to some aspects, the graph completion unit is configured to identify a pair of checkpoints where the connection relationship is not formed by searching for a path corresponding to an element of 0 among elements excluding a diagonal matrix in an adjacency matrix representing the connection relationship of the plurality of checkpoints.

According to some aspects, the graph completion unit is configured to define the virtual path as a detour path connecting the pair of checkpoints where the connection relationship is not formed through at least one checkpoint.

According to some aspects, the path identification unit is configured to: generate a 3D model of the industrial structure based on the industrial structure information, and identify the path on which the drone is movable and the path on which the drone is unmovable at the plurality of checkpoints by using the 3D model of the industrial structure.

According to some aspects of the disclosure, a method for generating movement paths of a plurality of drones for inspection of an industrial structure, the method comprising the steps of: receiving industrial structure information and a plurality of checkpoints of the industrial structure, identifying a path on which the drone is movable and a path on which the drone is unmovable at the plurality of checkpoints in consideration of the industrial structure information, defining a connection relationship of the checkpoints corresponding to the path on which the drone is movable, completing a relationship of the plurality of checkpoints by defining a virtual path between the checkpoints where the connection relationship is not defined, outputting a solution by solving a vehicle routing problem model configured based on the plurality of checkpoints, and generating the movement path based on the outputted solution, wherein the movement path includes sub-movement paths corresponding to the plurality of drones, respectively, wherein the step of outputting the solution includes the steps of: searching for a solution based on a weight according to the connection relationship of the plurality of checkpoints, evaluating fitness by performing conformity evaluation for the searched solution based on operation efficiency for the plurality of drones, ending problem solving in case that the evaluated fitness satisfies an algorithm end condition, solving the vehicle routing problem model through a metaheuristic technique configured to repeat the problem solving by changing the weight in case that the evaluated fitness does not satisfy the algorithm end condition, and wherein the step of outputting the solution includes the step of ending the problem solving and outputting the searched solution in case that the problem solving is performed as many times as the preset number of repetitions of the problem solving.

According to some aspects of the disclosure, a system for inspecting an industrial structure comprises, a plurality of drones configured to inspect the industrial structure, a plurality of control devices configured to correspond to the plurality of drones, respectively, and a path generation apparatus configured to, generate movement paths of the plurality of drones, the movement path including sub-movement paths corresponding to the plurality of drones, respectively, and provide the sub-movement paths to at least one of the corresponding drones and control devices, wherein the path generation apparatus includes, a data transceiver unit configured to receive industrial structure information and a plurality of checkpoints of the industrial structure, a path identification unit configured to, identify a path on which the drone is movable and a path on which the drone is unmovable at the plurality of checkpoints in consideration of the industrial structure information, and define a connection relationship of the checkpoints corresponding to the path on which the drone is movable, a graph completion unit configured to complete a relationship of the plurality of checkpoints by defining a virtual path between the checkpoints where the connection relationship is not defined, a problem solving unit configured to output a solution by solving a vehicle routing problem model configured based on the plurality of checkpoints; and a path generation unit configured to generate the movement path based on the outputted solution, wherein the movement path of the plurality of drones includes the sub-movement paths corresponding to the plurality of drones, respectively, wherein the problem solving unit is configured to, search for a solution based on a weight according to the connection relationship of the plurality of checkpoints, evaluate fitness by performing conformity evaluation for the searched solution based on operation efficiency for the plurality of drones, end problem solving in case that the evaluated fitness satisfies an algorithm end condition, and solve the vehicle routing problem model through a metaheuristic technique configured to repeat the problem solving by changing the weight in case that the evaluated fitness does not satisfy the algorithm end condition, and wherein the problem solving unit is configured to, end the problem solving, and output the searched solution in case that the problem solving is performed as many times as the preset number of repetitions of the problem solving.

According to some aspects, the drone is configured to: fly autonomously according to the movement path, or fly according to a control signal of the control device, wherein the drone is further configured to: generate location information, and provide the generated location information to the control device, and wherein the control device is configured to display the movement path and the location information together on a display to provide them to a user.

Aspects of the disclosure are not limited to those mentioned above and other objects and advantages of the disclosure that have not been mentioned can be understood by the following description and will be more clearly understood according to embodiments of the disclosure. In addition, it will be readily understood that the objects and advantages of the disclosure can be realized by the means and combinations thereof set forth in the claims.

The method and apparatus for generating movement paths of a plurality of drones for inspection of an industrial structure can identify paths on which the drones are movable and paths on which the drones are unmovable at a plurality of checkpoints based on industrial structure information, and can derive optimal movement paths of the drones by optimizing a vehicle routing problem model so that the operation efficiency of the plurality of drones is maximized through a metaheuristic technique.

Further, the method and apparatus for generating movement paths of a plurality of drones for inspection of an industrial structure can be configured to further solve a vehicle routing problem model through an exact solution, and determine a solving technique between the exact solution and metaheuristic technique based on the number of plural checkpoints. Accordingly, an accurate result that responds flexibly to on-site conditions can be transferred.

In addition to what is described above, specific effects of the present disclosure will be described together while illustrating the following specific details for carrying out the present disclosure.

### BRIEF DESCRIPTION OF THE DRAWINGS

FIG. 1 is a conceptual view explaining a system for inspecting an industrial structure according to some embodiments of the present disclosure.

FIG. 2 is a block diagram explaining in detail the configuration of a control device.

FIG. 3 is a block diagram explaining in detail the configuration of a drone.

FIG. 4 is a block diagram explaining in detail the configuration of a path generation apparatus.

FIG. 5 is an exemplary diagram explaining a process in which a path generation apparatus generates a movement path.

FIG. 6 shows an exemplary image obtained by visualizing a connection graph.

FIGS. 7 to 9 show exemplary images explaining a process of completing a connection graph.

FIG. 10 shows an exemplary image representing a generated movement path.

FIG. 11 is a flowchart of a method for generating movement paths of a plurality of drones for inspection of an industrial structure according to some embodiments of the present disclosure.

FIG. 12 is a flowchart explaining detailed steps of a step (S140) of FIG. 11.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

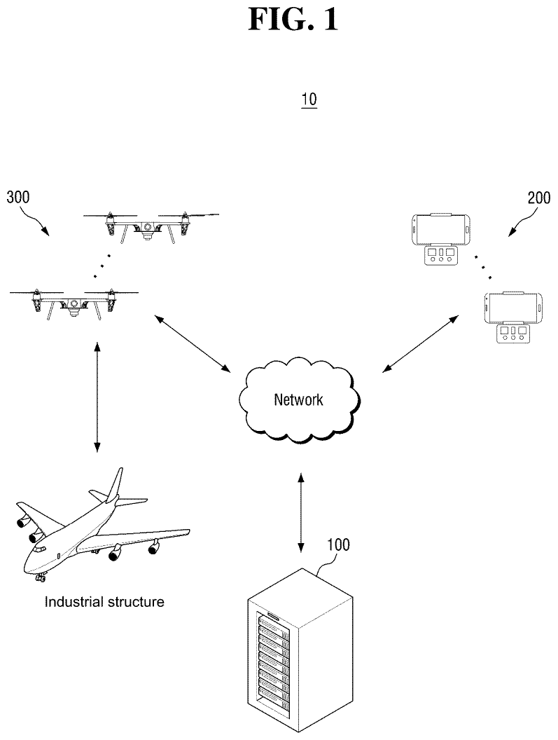

Hereinafter, with reference to FIGS. 1 to 12, a method for generating movement paths of a plurality of drones for checking of an industrial structure according to some embodiments of the present disclosure will be described in detail.

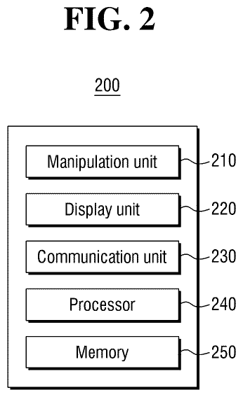

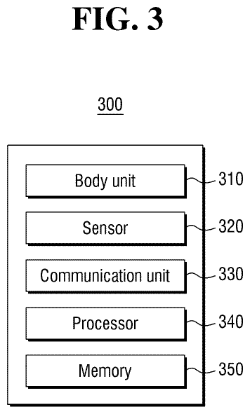

FIG. 1 is a conceptual view explaining a system for inspecting an industrial structure according to some embodiments of the present disclosure, FIG. 2 is a block diagram explaining in detail the configuration of a control device, and FIG. 3 is a block diagram explaining in detail the configuration of a drone.

Referring to FIG. 1, a system 10 for inspecting an industrial structure according to some embodiments of the present disclosure may include a path generation apparatus 100, a plurality of control devices 200, and a plurality of drones 300. The system 10 for inspecting an industrial structure may be a system that performs inspection of an industrial structure through the drones 300. In an embodiment, the industrial structure may mean a large facility of which the inspection requires a lot of people and money or which is too dangerous for human inspection. The industrial structure may be a building constructed for the purpose of operating a factory or an enterprise, but is not limited thereto, and a large airliner illustrated exemplarily in FIG. 1 may be included in such an industrial structure.

The path generation apparatus 100, the plurality of control devices 200, and the plurality of drones 300 may exchange data with each other through a network. In this case, the network may include networks by a wired internet technology, a wireless internet technology, and a near field communication technology. The wired internet technology may include, for example, at least one of a local area network (LAN) and a wide area network (WAN).

The wireless internet technology may include, for example, at least one of wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS), and 5G new radio (NR). However, the present embodiment is not limited thereto.

The near field communication technology may include, for example, Bluetooth, radio frequency identification (RFID), infrared data association (IrDA), ultra-wideband (UWB), ZigBee, near field communication (NFC), ultra-sound communication (USC), visible light communication (VLC), Wi-Fi, Wi-Fi Direct, and 5G new radio (NR). However, the present embodiment is not limited thereto.

The drone 300, the control device 200, and the path generation apparatus 100, which communicate with each other through the network, may comply with the technical standards and the standard communication method for mobile communication. For example, the standard communication method may include at least one of global system for mobile communication (GSM), code division multi-access (CDMA), code division multi-access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and 5G new radio (NR). However, the present embodiment is not limited thereto.

For example, each drone 300 may be connected to the corresponding control device 200 through the near field communication technology, and each control device 200 and the path generation apparatus 100 may be connected through wired/wireless internet technology. However, the present embodiment is not limited thereto.

In an embodiment, the path generation apparatus 100 may receive a plurality of checkpoints for inspection of the industrial structure. The path generation apparatus 100 may generate movement paths for movement of the plurality of drones based on the generated checkpoints. A process in which the path generation apparatus 100 generates the movement paths will be described in detail later. The movement paths generated by the path generation apparatus 100 may include a plurality of sub-movement paths divided in response to the number of drones, and one of the plurality of sub-movement paths may be provided to each drone 300 and the corresponding control device 200.

The control device 200 may be user equipment for controlling the corresponding drone 300. Referring to FIG. 2, the control device 200 may include a manipulation unit 210, a display unit 220, a communication unit 230, a processor 240, and a memory 250.

User's manipulation may be input to the manipulation unit 210. Exemplarily, the manipulation unit 210 may include a joystick for direction control of the drone and at least one button for inputting a user command, but the present embodiment is not limited thereto. In response to the user's manipulation through the manipulation unit 210, the processor 240 may control the movement direction of the drone 300, or may generate a user control signal for controlling the component included in the drone 300. The memory 250 is configured to store data required for data processing performed by the processor 240 or data that is generated by data processing of the processor 240.

The communication unit 230 may be configured to exchange data with at least one of the path generation apparatus 100 and the drone 300 through the network. The processor 240 enables a user to perform manual flight of the drone 300 by transmitting the generated control signal to the drone 300 through the communication unit 230.

Further, the processor 240 may display a sub-movement path received from the path generation apparatus 100 on the display unit 220, and may support user's manual operation of the drone 300 with reference to the sub-movement path. That is, the user may operate the drone 300 with reference to the sub-movement path that is displayed on the display unit 220, and may operate the drone 300 to follow the sub-movement path.

Referring to FIG. 3, the drone 300 may include a body unit 310, a sensor 320, a communication unit 330, a processor 340, and a memory 350.

The body unit 310 is configured to put the drone 300 in the air and to move the drone 300 in one direction in consideration of lift, gravity, thrust, and drag which act on the drone 300. The body unit 310 may include a plurality of rotors configured to generate the lift in order to overcome the gravity and to put the aircraft in the air and configured to generate the thrust for overcoming an aerodynamic drag. The body unit 310 may be able to move in one direction or to change its direction.

The sensor 320 may generate sensing information by detecting the component of an industrial structure. The sensor 320 may include an image sensor, and the sensing information may be image information that is generated through imaging of the exterior of the industrial structure. A user may be able to check cracks or damages occurring on the exterior of the industrial structure through the image information. Further, the sensor 320 includes a RiDAR sensor, and the distance between the drone 300 and the industrial structure can be maintained through the sensing information that is detected through the RiDAR sensor. Further, the sensor 320 may be configured to include a GPS, and the sensing information of the drone 300 may include location information.

The communication unit 330 may be configured to exchange data with the corresponding control device 200 or path generation apparatus 100 through the network. In accordance with the control signal that is provided from the control device 200 through the communication unit 330, the processor 340 may perform the inspection of the industrial structure through the drone 300 by controlling the body unit 310 and the sensor 320.

The memory 350 is configured to store data required for data processing performed by the processor 340 or data that is generated by data processing of the processor 340.

Here, the drone 300 may be controlled by the corresponding control device 200 to perform the manual flight, but the present embodiment is not limited thereto. The drone 300 may be configured to perform an autonomous flight along the sub-movement path generated by the path generation apparatus 100. That is, the processor 340 may control the body unit 310 and the sensor 320 to perform the inspection of the industrial structure while the drone 300 performs the autonomous flight to follow the sub-movement path.

In an embodiment, among the sensing information that is generated by the drone 300, the image information and the location information may be provided to the corresponding control device 200 in real time or in near real time. The processor 240 of the control device 200 may support that the user checks the state of the industrial structure in real time or in near real time by displaying the image information on the display unit 220. Further, the processor 240 of the control device 200 may support that the user checks the real-time location of the drone 300 and controls the drone 300 by displaying the location information together with the sub-movement path that is displayed on the display unit 220. In case of a manual operation mode, the user may control the drone 300 to follow the sub-movement path in consideration of the real-time location of the drone 300. In case of an autonomous operation mode, the user may monitor the autonomous flight state of the drone 300 by comparing the location of the drone 300 and the sub-movement path with each other. In an exemplary embodiment, if it is checked that the drone 300 deviates from the sub-movement path, the user may operate the drone 300 manually by changing the operation state of the drone 300 to the manual operation mode.

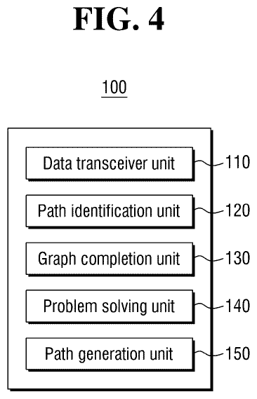

The path generation apparatus 100 may generate a movement path for inspection of the industrial structure based on a plurality of checkpoints of the industrial structure. Hereinafter, a process of generating a movement path, which is performed by the path generation apparatus, will be described with reference to FIGS. 4 to 10.

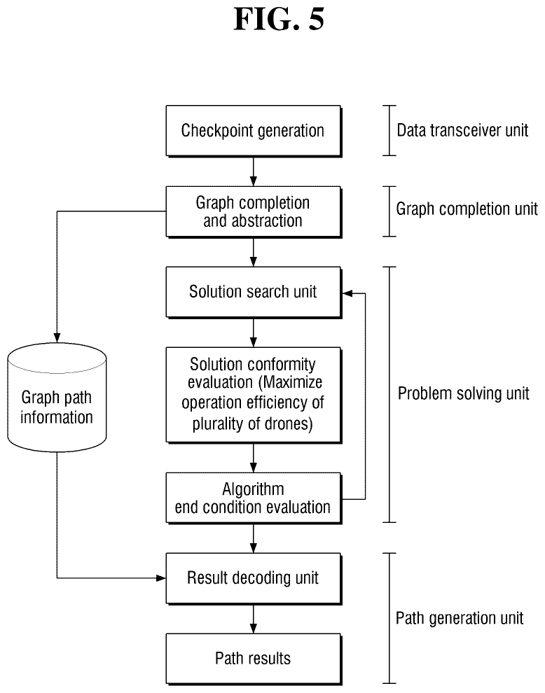

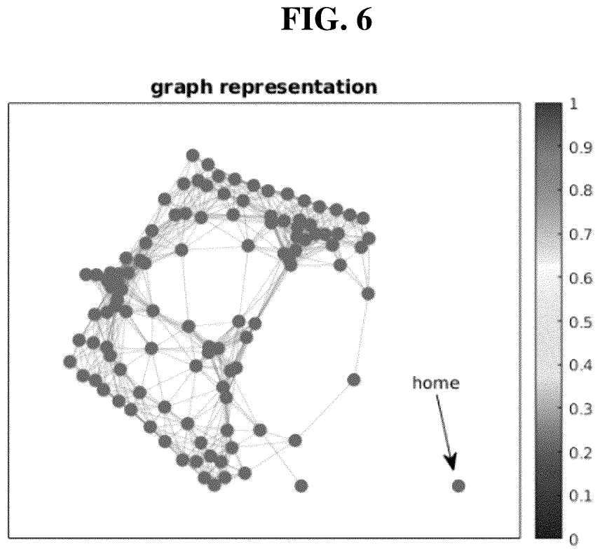

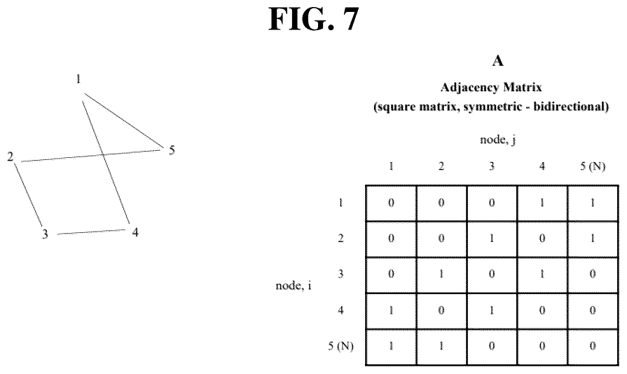

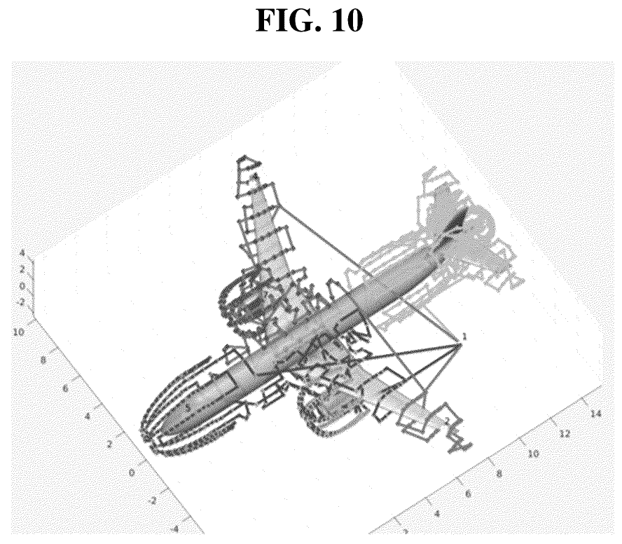

FIG. 4 is a block diagram explaining in detail the configuration of a path generation apparatus. FIG. 5 is an exemplary diagram explaining a process in which a path generation apparatus generates a movement path. FIG. 6 shows an exemplary image obtained by visualizing a connection graph. FIGS. 7 to 9 show exemplary images explaining a process of completing a connection graph. FIG. 10 shows an exemplary image representing a generated movement path.

Inspection of an industrial structure by a drone may be performed through a method in which a drone performs inspection by visiting a specific checkpoint and a method in which a drone checks the component on a path while following the path connecting the checkpoints. Accordingly, an optimal movement path may be generated by defining a plurality of checkpoints in accordance with the structure of the industrial structure and determining an optimal order of drone visits to a plurality of checkpoints.

In this regard, it corresponds to an NP hard problem that a plurality of drones 300 determine the order of visits to the plurality of checkpoints, and thus it corresponds to a vehicle routing problem in that there are constraints on vehicle capacity in which battery capacity limitations of the drone 300 are considered. The path generation apparatus 100 according to an embodiment of the present disclosure may configure a vehicle routing problem model based on the plurality of checkpoints of the industrial structure, derive an optimal solution by solving the configured vehicle routing problem model through a metaheuristic technique or an exact solution, and generate movement paths of the plurality of drones based on the derived solution.

Specifically, referring to FIG. 4, the path generation apparatus 100 includes a data transceiver unit 110, a path identification unit 120, a graph completion unit 130, a problem solving unit 140, and a path generation unit 150. In FIG. 4, although the data transceiver unit 110, the path identification unit 120, the graph completion unit 130, the problem solving unit 140, and the path generation unit 150 are illustrated as separate blocks which are distinguished from one another, this is merely to separate them functionally by operations that are executed by components constituting the path generation apparatus 100. Accordingly, depending on the embodiments, some or all of the components may be integrated into one same device.

Further, FIG. 5 may match and represent the relationship between a main process for the path generation apparatus 100 to generate a movement path and each component. Hereinafter, explanation will be made with reference to FIGS. 4 and 5.

The data transceiver unit 110 may receive a plurality of checkpoints of an industrial structure that is subject to inspection. The plurality of checkpoints of the industrial structure may be in a predefined state in consideration of the characteristics and specifications of the industrial structure and an inspection distance of the drone. The plurality of checkpoints may be defined as locations of specific components requiring detailed inspection among the components of the industrial structure, but are not limited thereto, and the plurality of checkpoints may be defined as locations for generating a path through which the specific components requiring the inspection pass. The drone 300 may inspect a main area in a state where the location of the drone 300 is fixed at each checkpoint for a predetermined time, and may perform inspection of the main area of the industrial structure while moving between the checkpoints.

Further, the data transceiver unit 110 may also receive industrial structure information including information about the characteristics and specifications of the industrial structure. In an embodiment, the plurality of checkpoints of the industrial structure and the industrial structure information may be data that is received from a control server (not illustrated) of the industrial structure, but are not limited thereto.

Further, the data transceiver unit 110 may be configured to transmit movement paths generated through a process described later to at least one of the plurality of drones and the plurality of control devices 200.

The path identification unit 120 may identify movable paths and unmovable paths of the drones at a plurality of checkpoints in consideration of the industrial structure information.

Theoretically, the plurality of checkpoints may form a path through connection of all the checkpoints. However, in consideration of the actually implemented structure of the industrial structure and the flight characteristics of the drone 300 that is not easy to be driven on curves, points where drone movement is not easy or is not realistically possible may exist. That is, according to geometric limits, the plurality of checkpoints may not be connected in all.

The path identification unit 120 may identify the path on which drone's movement is not possible in consideration of the industrial structure information. The path identification unit 120 may identify the path on which drone's movement is not possible in consideration of the industrial structure information, and may not configure the connection relationship of the checkpoints corresponding to the unmovable path. The path identification unit 120 may define the path of the plurality of checkpoints as the path on which drone's movement is possible, rather than the path on which the drone's movement is not physically possible.

The path identification of the path identification unit 120 may be determined based on a three-dimensional (3D) model implemented based on the industrial structure information. In an embodiment, the path identification unit 120 may implement the 3D model of the industrial structure based on the industrial structure information, and may display the determined plurality of checkpoints together by reflecting the checkpoints in the 3D mode of the industrial structure. The path identification unit 120 may identify the path on which the drone 300 is movable and the path on which the drone 300 is unmovable by utilizing the plurality of checkpoints displayed together with the 3D model of the industrial structure.

The path identification unit 120 may determine the movable path between the plurality of checkpoints, and may determine a weight for the determined path. Here, the weight may be a moving cost that is applied in proportion to the distance between the checkpoints or a movement time between the checkpoints, but is not limited thereto. Because the checkpoints are not connected on the unmovable path, the path identification unit 120 may not set a weight for the unmovable path. The path identification unit 120 may connect all movable paths of the plurality of checkpoints, and may represent the connection relationship of the plurality of checkpoints as a visualized (graph-represented) connection graph. As visualized (graph-represented) information shown in FIG. 6, the connection graph representing the connection relationship may be transferred to the user.

In case of the connection graph configured through the path identification unit 120, the connection graph is so configured that only movable paths are connected to one another, and is in the form of an incomplete graph. Referring to FIG. 7, in the connection graph of node 1 to node 5, it can be seen that the connection relationship is not formed between node 1 and node 2, between node 1 and node 3, between node 2 and node 4, between node 3 and node 5, and between node 4 and node 5. In an adjacency matrix representing the relationship among node 1 to node 5, it can be seen the corresponding path appears as 0, and the path having the connection relationship appears as 1. That is, a pair of checkpoints which is determined as an unmovable path and does not form the connection relationship may appear as 0 in the adjacency matrix.

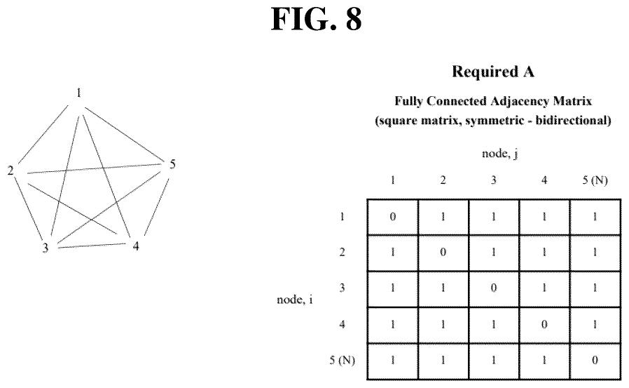

A complete graph means a graph in which connection relationships among all nodes (checkpoints) are formed. Referring to FIG. 8, it can be seen that node 1 to node 5 are in a state where all connection relationships are formed. That is, in the adjacency matrix representing the relationships among node 1 to node 5, it can be seen that only the diagonal matrix appears as 0.

In an embodiment, the vehicle routing problem model VRP is solvable only in the complete graph. That is, the connection relationship of the plurality of checkpoints connected through the path identification unit 120 is in an incomplete connection state, and completion is needed to solve the vehicle routing problem model VRP.

The graph completion unit 130 may generate virtual paths for completion of the connection relationship of the plurality of checkpoints. Here, the completion may mean forming of all connectivity among the plurality of checkpoints.

First, the graph completion unit 130 may generate the virtual paths so as to define the connection relationship of the non-connected pairs of checkpoints in the connection graph. The graph completion unit 130 may search for a path that corresponds to an element of 0 among elements excluding the diagonal matrix in the adjacency matrix representing the connection relationship of the plurality of checkpoints by utilizing Dijkstra's algorithm. The graph completion unit 130 may search for the element of 0 among the elements excluding the diagonal matrix, and may define the virtual path for the connection relationship of the corresponding pair of checkpoints.

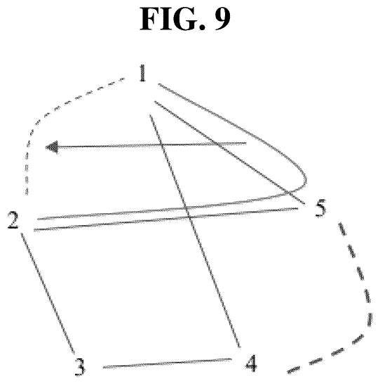

Here, the virtual path may mean a detour path (route) connected through at least one checkpoint. The graph completion unit 130 may set a detour path for the pair of checkpoints in a non-connected state. Referring to FIG. 9, a path (dotted line) set between node 1 and node 2 is an implicit virtual path, and an actually applied path may be defined as a detour path through a different pair of checkpoints. Accordingly, the plurality of checkpoints may be converted into a completion state in which the checkpoints constitute the complete graph. That is, in the adjacency matrix of the complete graph of the plurality of checkpoints, all elements excluding the diagonal matrix may be in a state where they are not 0. In such a completion state, the solution for the plurality of checkpoints may be possible. Further, the detour path is a path that is connected through at least one checkpoint, and a higher weight than the weight may be set for the detour path as compared to the weight in a state where the pairs of checkpoints are directly connected in the connection graph. That is, a high detour (bypass) cost is applied to the detour path, and thus the detour path may be naturally excluded in a process of deriving the optimal path to be described later.

In another embodiment, the graph completion unit 130 may define the virtual path by identifying the checkpoint in a non-connected state and setting a random weight for the identified checkpoint. The random weight corresponds to a higher value than the weight according to the distance and movement time of the pair of checkpoints, and a high detour cost is applied to the detour path, and thus the detour path may be naturally excluded in a process of deriving the optimal path to be described later.

The problem solving unit 140 may solve the optimal path of the plurality of checkpoints in a complete connection state, that is, the checkpoints expressed by the complete graph, through configuration as the vehicle routing model. The problem solving unit 140 may solve the optimal path by configuring the vehicle routing problem model CVRP having constraints on vehicle capacity in which battery capacity limitations of the drone 300 are considered. Further, the vehicle routing problem model may formulate the problem by considering the plurality of drones and the battery capacity (usage time) of the drone and adding conditions so that the overlapping checkpoints between the sub-movement paths correspond to only a starting point (depot). Accordingly, the plurality of drones the number of which corresponds to the number of sub-movement paths operate simultaneously, and thus the inspection of the industrial structure may be possible. In an embodiment, the vehicle routing problem model that performs optimization of an objective function while satisfying the following constraints may be configured through a linear integer programming method as in Mathematical expression 1 below.

$$\begin{matrix}[ Mathematical expression 1 ] & \\ Minimize {\sum }_{r = 1}^{p} {\sum }_{i = 0}^{n} {\sum }_{j = 0 , i \neq j}^{n} {c}_{ij} {x}_{rij} , & ( 1 )\end{matrix}$$

$$\begin{matrix}Subject to {\sum }_{r = 1}^{p} {\sum }_{i = 0 , i \neq j}^{n} {x}_{rij} = 1 , & ∀ j ∈ \{ 1 , … , n \} ,\end{matrix} \qquad ( 2 )$$

$$\begin{matrix}{\sum }_{j = 1}^{n} {x}_{r 0 j} = 1 , & ∀ r ∈ \{ 1 , … , p \} ,\end{matrix} \qquad ( 3 )$$

$$\begin{matrix}{\sum }_{i = 0 , i \neq j}^{n} {x}_{rij} = {\sum }_{i = 0}^{n} {x}_{rji} , & ∀ j ∈ \{ 0 , … , n \} , r ∈ \{ 1 , … , p \} ,\end{matrix} \qquad ( 4 )$$

$$\begin{matrix}{\sum }_{i = 0}^{n} {\sum }_{j = 1 , i \neq j}^{n} {d}_{j} {x}_{rij} ≦ Q , & ∀ r ∈ \{ 1 , … , p \} ,\end{matrix} \qquad ( 5 )$$

$$\begin{matrix}{\sum }_{r = 1}^{p} {\sum }_{i ∈ 𝒮} {\sum }_{j ∈ 𝒮 , i \neq j} {x}_{rij} ≦ \vert 𝒮 \vert - 1 , & ∀ 𝒮 ⊆ \{ 1 , … , n \} ,\end{matrix} \qquad ( 6 )$$

$$\begin{matrix}{x}_{rij} ∈ \{ 0 , 1 \} , & ∀ r ∈ \{ 1 , … , p \} , i , j ∈ \{ 0 , … , n \} , i \neq j .\end{matrix} \qquad ( 7 )$$

Here, n and p mean integers that are larger than 1, i and j correspond to different checkpoints in which i means a starting point (depot) and j means an arrival point; r means a drone; cᵢⱼ means a cost function that moves from the i-th checkpoint to the j-th checkpoint; Xᵣᵢⱼ corresponds to a binary decision variable for representing drone's movement onto a path (i, j); Q means a flight time depending on the battery capacity of the drone; dⱼ means a flight time to the checkpoint j, and S means a subset of checkpoints.

In the above Mathematical expression 1, the objective function (1) aims to minimize the overall movement cost. Here, the cost function of the objective function (1) may be configured based on the connection relationship of the plurality of checkpoints, and cost values incurred due to movement of paths i to j may be set.

The model constraint (2) is the degree constraint, and in this case, the drone's visit to each checkpoint may be guaranteed. The flow constraints (3) and (4) guarantee that the drone can leave the starting point (depot) only once, and the number of drones that arrive at all nodes and enter the starting point is equal to the number of leaving drones.

In the constraint (5), the capacity constraint is specified, and it can be checked if the total flight time of the drone is equal to or less than the flight time according to the battery capacity. Accordingly, an optimal path can be set in consideration of the battery capacity of the drone.

The sub-path (sub-tour) prevention constraint (6) makes the path start surely from the starting point and return finally to the starting point. The remaining mandatory constraint (7) designates a variable definition area, and the binary decision variable may be 0 or 1.

The problem solving unit 140 may solve the above-described formulated vehicle routing problem model CVRP through an exact solution or a metaheuristic technique. In an embodiment, the problem solving unit 140 may determine the solving technique depending on the number of the checkpoints generated in consideration of the industrial structure information. The problem solving unit 140 may include a reference checkpoint threshold value preset in accordance with the type and size of the industrial structure.

The problem solving unit 140 may determine a technique to solve the vehicle routing problem model CVRP in accordance with the reference checkpoint threshold value. If the number of the checkpoints is larger than the threshold value, a lot of time and resources may be consumed for accurate calculations, and it may be difficult to respond immediately to field needs. In order to output efficient results, it may be required to properly select the solving technique.

If the number of checkpoints is equal to or less than the threshold value, the solution may be performed through the exact solution. In an embodiment, the problem solving unit 140 may solve the vehicle routing problem model through a branch and bound method. The branch and bound method may eliminate a solution that is judged to be hopeless by estimating upper and lower limits of the numerical value to be optimized while arranging all candidate solutions systematically. Because solutions that are derived from the solutions that are eliminated are not examined, unnecessary time consumption can be reduced, and the optimal solution can be derived.

Here, if the number of checkpoints (nodes) becomes large, the computation time difference between the two techniques may increase exponentially. If the number of the checkpoints is larger than the threshold value, the problem solving unit 140 may perform the solution through the metaheuristic technique. Because the industrial structure has a complicated structure and a large size, a large number of checkpoints may be derived, and with respect to the industrial structure, the problem solving through the metaheuristic technique may be a more appropriate solution method.

Referring to FIG. 5, the problem solving unit 140 may search for a solution based on the weight according to the connection relationship of the plurality of checkpoints. The problem solving unit 140 may evaluate the fitness by performing the fitness evaluation for the searched solution based on the operation efficiency for the plurality of drones. Specifically, the problem solving unit 140 may perform a conformity evaluation so that efficient movement paths with the small number of drones can be derived by checking whether the inspection time of each drone is maximally secured. In an embodiment, the problem solving unit 140 may output the optimal solution through a conformity judgment algorithm min (max (inspection time of each drone) in which the number of drones is minimized while the inspection time of each drone is maximized. Accordingly, the movement paths of the plurality of drones to make the most of the plurality of checkpoints with a minimum of drones can be generated.

If the evaluated conformity satisfies an algorithm end condition, the problem solving unit 140 ends the problem solving, whereas if the evaluated conformity does not satisfy the algorithm end condition, the problem solving unit 140 repeats the problem solving by changing the graph weight. If the evaluated conformity satisfies the algorithm end condition, or the problem solving is performed as many times as the preset number of repetitions of problem solving, the problem solving unit 140 ends the problem solving, and outputs the results of the problem solving.

In an embodiment, the problem solving unit 140 may derive the optimal solution through an ant colony system (ACS) of the metaheuristic technique. The ant colony system is a metaheuristic technique to mimic the actual ability of ants to find a shortest path from food to home. Specifically, the ant colony system (ACS) is a system that applies the principle to the heuristic search, in which ants which are called agents secrete pheromones in each path while moving toward their destinations, and the agents passing by later select the next path by using the pheromone information accumulated in the path. The problem solving unit 140 may search for the solution by further utilizing the pheromone information accumulated in the existing path as positive feedback information. That is, the problem solving unit 140 may perform the problem solving (complete the search path) by utilizing not only the weight according to the connection relationship of the plurality of checkpoints but also the positive feedback (pheromone information), and thus may output a more optimized path.

The path generation unit 150 may generate the movement path based on the optimal solution derived from the problem solving unit 140 and the complete graph. The movement path may include the sub-movement paths on which each of the plurality of drones moves through the plurality of checkpoints. The number of the plurality of drones 300 may be the minimum number, and the sub-movement paths may be configured so that each drone has as much flight time as possible. As the overlapping node between the sub-movement paths, the starting point (depot) may be the only points. Accordingly, the plurality of drones the number of which corresponds to the number of sub-movement paths operate simultaneously to perform inspection of the industrial structure.

Further, in an embodiment, the problem solving unit 140 may display the generated movement path together with the 3D model of the industrial structure. FIG. 10 exemplarily illustrates a schematic 3D model of an industrial structure and a generated movement path together, and it can be seen that four sub-movement paths constitute a movement path. That is, four drones may perform inspection for the industrial structure along the corresponding sub-movement paths.

Further, in an embodiment, the movement path may further include speed information according to the checkpoints. Accordingly, the drone 300 may move through the checkpoints in the order according to the movement path, and may be controlled to move on each path according to the set speed.

The path generation apparatus that generates the movement paths of the plurality of drones for inspection of the industrial structure according to an embodiment of the present disclosure may identify paths on which the drones are movable and paths on which the drones are unmovable at the plurality of checkpoints based on industrial structure information, and may derive the optimal movement paths of the drones by optimizing the vehicle routing problem model so that the operation efficiency of the plurality of drones is maximized through the metaheuristic technique.

Further, the path generation apparatus that generates the movement path for inspection of the industrial structure may be configured to further solve the vehicle routing problem model, and may determine the solving technique between the exact solution and the metaheuristic technique based on the number of the plurality of checkpoints. Accordingly, an accurate result that responds flexibly to on-site conditions may be transferred.

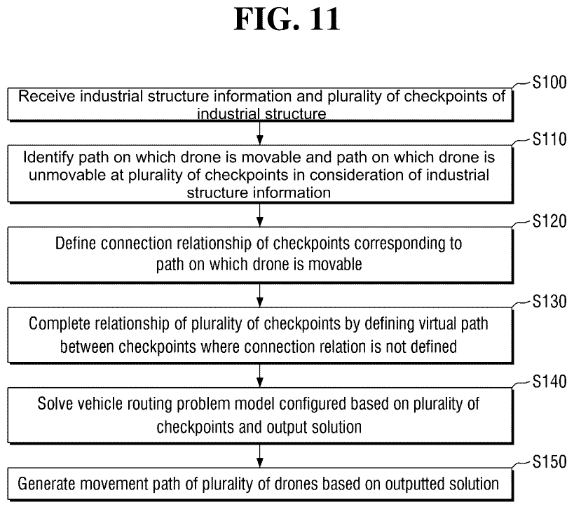

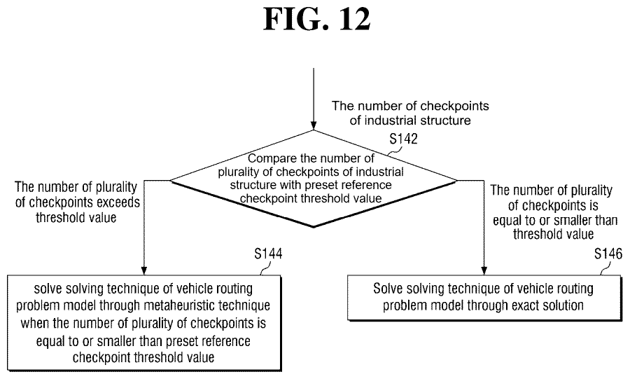

Hereinafter, referring to FIGS. 11 and 12, a method for generating movement paths of a plurality of drones for inspection of an industrial structure according to some embodiments of the present disclosure will be described. Because the method for generating movement paths of a plurality of drones for inspection of an industrial structure according to the embodiments is a method that is performed by the path generation apparatus according to FIGS. 1 to 10, the duplicate description of the above-described embodiments will be simplified or omitted.

FIG. 11 is a flowchart of a method for generating movement paths of a plurality of drones for inspection of an industrial structure according to some embodiments of the present disclosure. FIG. 12 is a flowchart explaining detailed steps of a step (S140) of FIG. 11.

Referring to FIG. 11, a method for generating movement paths of a plurality of drones for inspection of an industrial structure according to an embodiment includes the steps of: receiving industrial structure information and a plurality of checkpoints of the industrial structure (S100); identifying a path on which the drone is movable and a path on which the drone is unmovable at the plurality of checkpoints in consideration of the industrial structure information (S110); defining a connection relationship of the checkpoints corresponding to the path on which the drone is movable (S120); completing a relationship of the plurality of checkpoints by defining a virtual path between the checkpoints where the connection relationship is not defined (S130); outputting a solution by solving a vehicle routing problem model configured based on the plurality of checkpoints (S140); and generating the movement path based on the outputted solution (S150).

Here, the movement path may include sub-movement paths corresponding to the plurality of drones, respectively.

In an embodiment, the step of outputting the solution (S140) may include the steps of: searching for a solution based on a weight according to the connection relationship of the plurality of checkpoints; evaluating fitness by performing conformity evaluation for the searched solution based on operation efficiency for the plurality of drones; ending problem solving in case that the evaluated fitness satisfies an algorithm end condition; and solving the vehicle routing problem model through a metaheuristic technique configured to repeat the problem solving by changing the weight in case that the evaluated fitness does not satisfy the algorithm end condition.

In an embodiment, the step of outputting the solution (S140) may end the problem solving and output the searched solution in case that the problem solving is performed as many times as the preset number of repetitions of the problem solving.

In an embodiment, the metaheuristic technique may be an ant colony system (ACS), and the step of outputting the solution (S140) may include the step of searching for the solution by further utilizing pheromone information accumulated in an existing path as a positive feedback.

In an embodiment, the step of outputting the solution (S140) may be further configured to solve the vehicle routing problem model by an exact solution.

In an embodiment, the step of outputting the solution (S140) may include the step of determining a solving technique of the vehicle routing problem model between the metaheuristic technique and the exact solution according to the number of the plurality of checkpoints of the industrial structure.

Referring to FIG. 12, the step of outputting the solution (S140) may include the steps of: comparing the number of the plurality of checkpoints of the industrial structure with a preset reference checkpoint threshold value (S142); solving the solving technique of the vehicle routing problem model through the metaheuristic technique in case that the number of the plurality of checkpoints of the industrial structure exceeds the preset reference checkpoint threshold value (S144); and solving the solving technique of the vehicle routing problem model through the exact solution in case that the number of the plurality of checkpoints of the industrial structure is equal to or smaller than the preset reference checkpoint threshold value (S146).

In an embodiment, the vehicle routing problem model may be configured so that the overlapping checkpoint between the sub-movement paths corresponds to only a starting point (depot) in consideration of battery capacities of the plurality of drones.

In an embodiment, the step of completing the relationship of the plurality of checkpoints (S130) may include the step of identifying a pair of checkpoints where the connection relationship is not formed by searching for a path corresponding to an element of 0 among elements excluding a diagonal matrix in an adjacency matrix representing the connection relationship of the plurality of checkpoints.

In an embodiment, the virtual path may be defined as a detour path connecting the pair of checkpoints where the connection relationship is not formed through at least one checkpoint.

In an embodiment, the step of identifying the path on which the drone is movable and the path on which the drone is unmovable at the plurality of checkpoints in consideration of the industrial structure information (S110) may generate a 3D model of the industrial structure based on the industrial structure information, and may identify the path on which the drone is movable and the path on which the drone is unmovable at the plurality of checkpoints by using the 3D model of the industrial structure.

The method for generating movement paths of a plurality of drones for inspection of an industrial structure according to an embodiment may be implemented in the form of a computer-readable medium that stores instructions executable by a computer and data. In this case, the instructions and data may be stored in the form of a program code, and when being executed by a processor, a specific operation may be performed through generation of a specific program module. Further, the computer-readable medium may be any available medium that can be accessed by a computer, and may include all of volatile and nonvolatile media, and removable and non-removable media. Further, the computer-readable medium may be a computer recording medium, and the computer recording medium may include all of volatile and nonvolatile media, and removable and non-removable media implemented by a certain method or technology for storing computer-readable instructions, data structures, program modules, or information such as other data. For example, the computer recording medium may be a magnetic storage medium such as HDD and SSD, an optical recording medium such as CD, DVD, and Blu-ray disc, or a memory included in a server that is accessible through a network.

Further, the method for generating movement paths of a plurality of drones for inspection of an industrial structure according to an embodiment may be implemented by a computer program (or computer program product) including instructions executable by a computer. The computer program includes programmable machine instructions being processed by a processor, and may be implemented in high-level programming language, object-oriented programming language, assembly language, or machine language. Further, the computer program may be recorded in a tangible computer-readable recording medium (e.g., memory, hard disk, magnetic/optical medium, or solid-state drive (SSD)).

Accordingly, the method for generating movement paths of a plurality of drones for inspection of an industrial structure according to an embodiment may be implemented by being executed by a computing device. The computing device may include at least some of a processor, a memory, a storage device, a high-speed interface connected to a memory and a high-speed extension port, and a low-speed interface connected to a low-speed bus and storage device. Such components may be connected by using various buses, and may be mounted on a common mother board or in other proper ways.

Here, the processor may process instructions within the computing device, and such instructions may be, for example, instructions stored in a memory or a storage device in order to display graphic information for providing a graphic user interface (GUI) on the external input and output devices like a display connected to the high-speed interface. As another embodiment, plural processors and/or plural buses may be properly used together with plural memories and memory forms. Further, the processor may be implemented as a chipset constituted by chips including plural independent analog and/or digital processors.

Further, the memory stores information within the computing device. As an example, the memory may be composed of volatile memory units or a set thereof. Further, the memory may be, for example, a computer-readable medium of a different type, such as a magnetic or optical disc.

Further, the storage device may provide a large storage space to the computing device. The storage device may be a computer-readable medium or a constitution including such a medium, and may include, for example, devices or other constitutions in a storage area network (SAN), and may be a floppy disk device, a hard disk device, an optical disk device, or a tape device, a flash memory, or another similar semiconductor memory device or device array.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

1. A path generation apparatus for generating movement paths of a plurality of drones for inspection of an industrial structure, the path generation apparatus comprising:
a data transceiver unit configured to receive industrial structure information and a plurality of checkpoints of the industrial structure;
a path identification unit configured to: identify a path on which the drone is movable and a path on which the drone is unmovable at the plurality of checkpoints in consideration of the industrial structure information, and define a connection relationship of the checkpoints corresponding to the path on which the drone is movable;
a graph completion unit configured to complete a relationship of the plurality of checkpoints by defining a virtual path between the checkpoints where the connection relationship is not defined;
a problem solving unit configured to output a solution by solving a vehicle routing problem model configured based on the plurality of checkpoints; and
a path generation unit configured to generate the movement path of the plurality of drones based on the outputted solution,
wherein the movement path of the plurality of drones includes sub-movement paths corresponding to the plurality of drones, respectively,
wherein the problem solving unit is configured to: search for a solution based on a weight according to the connection relationship of the plurality of checkpoints, evaluate fitness by performing conformity evaluation for the searched solution based on operation efficiency for the plurality of drones, end problem solving in case that the evaluated fitness satisfies an algorithm end condition, and solve the vehicle routing problem model through a metaheuristic technique configured to repeat the problem solving by changing the weight in case that the evaluated fitness does not satisfy the algorithm end condition, and
wherein the problem solving unit is configured to: end the problem solving, and output the searched solution in case that the problem solving is performed as many times as the preset number of repetitions of the problem solving.

2. The path generation apparatus of claim 1, wherein the metaheuristic technique is an ant colony system (ACS), and
wherein the problem solving unit is configured to search for the solution by further utilizing pheromone information accumulated in an existing path as a positive feedback.

3. The path generation apparatus of claim 1, wherein the problem solving unit is further configured to solve the vehicle routing problem model by an exact solution,
wherein the problem solving unit is configured to determine a solving technique of the vehicle routing problem model either the metaheuristic technique or the exact solution according to the number of the plurality of checkpoints of the industrial structure, and
wherein the problem solving unit is configured to: solve the solving technique of the vehicle routing problem model through the metaheuristic technique in case that the number of the plurality of checkpoints of the industrial structure exceeds a preset reference checkpoint threshold value, and solve the solving technique of the vehicle routing problem model through the exact solution in case that the number of the plurality of checkpoints of the industrial structure is equal to or smaller than the preset reference checkpoint threshold value.

4. The path generation apparatus of claim 1, wherein the vehicle routing problem model is configured so that the overlapping checkpoint between the sub-movement paths corresponds to only a starting point (depot) in consideration of battery capacities of the plurality of drones.

5. The path generation apparatus of claim 1, wherein the graph completion unit is configured to identify a pair of checkpoints where the connection relationship is not formed by searching for a path corresponding to an element of 0 among elements excluding a diagonal matrix in an adjacency matrix representing the connection relationship of the plurality of checkpoints.

6. The path generation apparatus of claim 5, wherein the graph completion unit is configured to define the virtual path as a detour path connecting the pair of checkpoints where the connection relationship is not formed through at least one checkpoint.

7. The path generation apparatus of claim 1, wherein the path identification unit is configured to: generate a 3D model of the industrial structure based on the industrial structure information, and identify the path on which the drone is movable and the path on which the drone is unmovable at the plurality of checkpoints by using the 3D model of the industrial structure.

8. A method for generating movement paths of a plurality of drones for inspection of an industrial structure, the method comprising the steps of:
receiving industrial structure information and a plurality of checkpoints of the industrial structure;
identifying a path on which the drone is movable and a path on which the drone is unmovable at the plurality of checkpoints in consideration of the industrial structure information;
defining a connection relationship of the checkpoints corresponding to the path on which the drone is movable;
completing a relationship of the plurality of checkpoints by defining a virtual path between the checkpoints where the connection relationship is not defined;
outputting a solution by solving a vehicle routing problem model configured based on the plurality of checkpoints; and
generating the movement path based on the outputted solution,
wherein the movement path includes sub-movement paths corresponding to the plurality of drones, respectively,
wherein the step of outputting the solution includes the steps of: searching for a solution based on a weight according to the connection relationship of the plurality of checkpoints; evaluating fitness by performing conformity evaluation for the searched solution based on operation efficiency for the plurality of drones; ending problem solving in case that the evaluated fitness satisfies an algorithm end condition; and solving the vehicle routing problem model through a metaheuristic technique configured to repeat the problem solving by changing the weight in case that the evaluated fitness does not satisfy the algorithm end condition, and
wherein the step of outputting the solution includes the step of ending the problem solving and outputting the searched solution in case that the problem solving is performed as many times as the preset number of repetitions of the problem solving.

9. A system for inspecting an industrial structure comprising:
a plurality of drones configured to inspect the industrial structure;
a plurality of control devices configured to correspond to the plurality of drones, respectively; and
a path generation apparatus configured to: generate movement paths of the plurality of drones, the movement path including sub-movement paths corresponding to the plurality of drones, respectively, and provide the sub-movement paths to at least one of the corresponding drones and control devices,
wherein the path generation apparatus includes:
a data transceiver unit configured to receive industrial structure information and a plurality of checkpoints of the industrial structure;
a path identification unit configured to: identify a path on which the drone is movable and a path on which the drone is unmovable at the plurality of checkpoints in consideration of the industrial structure information, and define a connection relationship of the checkpoints corresponding to the path on which the drone is movable;
a graph completion unit configured to complete a relationship of the plurality of checkpoints by defining a virtual path between the checkpoints where the connection relationship is not defined;
a problem solving unit configured to output a solution by solving a vehicle routing problem model configured based on the plurality of checkpoints; and
a path generation unit configured to generate the movement path based on the outputted solution,
wherein the movement path of the plurality of drones includes the sub-movement paths corresponding to the plurality of drones, respectively,
wherein the problem solving unit is configured to: search for a solution based on a weight according to the connection relationship of the plurality of checkpoints, evaluate fitness by performing conformity evaluation for the searched solution based on operation efficiency for the plurality of drones, end problem solving in case that the evaluated fitness satisfies an algorithm end condition, and solve the vehicle routing problem model through a metaheuristic technique configured to repeat the problem solving by changing the weight in case that the evaluated fitness does not satisfy the algorithm end condition, and
wherein the problem solving unit is configured to: end the problem solving, and output the searched solution in case that the problem solving is performed as many times as the preset number of repetitions of the problem solving.

10. The system of claim 9, wherein the drone is configured to: fly autonomously according to the movement path, or fly according to a control signal of the control device,
wherein the drone is further configured to: generate location information, and provide the generated location information to the control device, and
wherein the control device is configured to display the movement path and the location information together on a display to provide them to a user.
